(19) United States
(12) Patent Application Publication
(10) Pub. No.: US 2013/0188643 A1
(43) Pub. Date: Jul. 25, 2013

(54) METHOD AND APPARATUS FOR HYBRID PACKET/FABRIC SWITCH

(71) Applicant: Geoffrey Mattson, San Francisco, CA (US)

(72) Inventor: Geoffrey Mattson, San Francisco, CA (US)

(73) Assignee: Futurewei Technologies, Inc., Plano, TX (US)

(21) Appl. No.: 13/609,023

(22) Filed: Sep. 10, 2012

Related U.S. Application Data
(60) Provisional application No. 61/533,022, filed on Sep. 9, 2011.

(51) Int. Cl. H04L 12/56

(52) U.S. Cl. CPC H04L 49/60
USPC 370/392

(57) ABSTRACT

A hybrid data center switching system includes a first switching device, a routing/switching device, a core switching device and communication links. The first switching device has a plurality of external packet interfaces and a plurality of external fabric interfaces. The external packet interfaces are configured to receive and transmit data packets in accordance with a standards-based packet protocol. The external fabric interfaces are configured to receive and transmit data packets in accordance with a fabric protocol. The routing/switching device is coupled to the plurality of external packet interfaces via a first communications link. The core switching device has a packet interface and a fabric interface. The packet interface is coupled to the routing/switching device via a second communications link. A third communications link between the external fabric interfaces and the fabric interface of the core switching device is operable for transporting data packets in accordance with the fabric protocol.

### CROSS-REFERENCE TO RELATED APPLICATION

This application claims priority under 35 USC 119(e) to U.S. provisional Application Ser. No. 61/533,022, filed on Sep. 9, 2011, and which is incorporated herein by reference.

### TECHNICAL FIELD

The present disclosure relates to communications switching systems and, in particular, to a hybrid packet/fabric switch and system, and related methods of switching.

### BACKGROUND

Conventional Ethernet switches and Internet Protocol (IP) routers accept packets with standards encapsulation at their service interfaces and transmit packets in the same format. This method has the benefit of standard interoperability between vendors, consistent layer 2+ and layer 3 routing over multiple hops, and per-hop policy control. This conventional packet switch architecture is depicted in FIG. 1. Such system may be utilized in a data center configuration.

The system 100 (e.g., data center) includes a first switching device 110, a second switching device 120 and a core data center switching device 130. As will be appreciated, the term “switching device” refers to a device that has switching and/or routing capabilities, and are often referred to as a router or a switch, and the term “router, “switch” and “router/switch” are used interchangeably herein. In addition, although only one of each device 110, 120, 130 are shown, additional such devices may be incorporated within the data center system 100.

The second switching device 120 includes a first router/switch 120a and a second router/switch 120b. In some configurations, the second switching device is referred to as a top of rack switch (TORS). In general terms, the TORS 120 gathers and routes data packets into a communications pipe having large bandwidth. One example of TORS 120 may be those switches from Huawei Technologies, such as the CE5800 and CE680 TOR switches.

As shown in FIG. 1, the switching device 110 includes a first set of external packet interfaces 112a, a second set of external packet interfaces 112b, and an internal fabric interconnect 114. The external packet interfaces 112 are operable for coupling to one or more external packet networks/devices (not shown), such as for example, servers, routers, gateways, end systems, etc. The internal fabric interconnect 114 provides switching/interconnect functionality between the external packet interfaces.

The core data center switching device 130 provides backbone and core routing/switching functionality. One example of the core data center switch 130 may be a switch from Huawei Technologies, such as the CE12800 core switch.

Within the conventional prior art packet switch architecture, the data packets are communicated via communications links between the switching devices 110, 120, 130 using a publicly available and known standards-based packet protocol, such as Ethernet. Other examples of standards-based protocols include ATM, IP, and IPOE. As will be appreciated, the term “standards-based packet protocol” refers to a published or publicly available standard describing or defining the parameters and operation of the protocol.

A newer architecture is emerging that allows a switch/router to receive and transmit data packets according to a “fabric” protocol. This fabric switch architecture or data center system 200 is depicted in FIG. 2. The system 200 includes a first switching device 210, a data center core switching device 230 and a fabric connection (or communication link) 220 therebetween. Although only one of each device 210, 220, 230 are shown, additional such devices may be incorporated within the data center system 200.

Fabric protocols are generally designed to operate within a small set of equipment and can be specifically tailored to the capabilities and constraints of those systems. Fabric protocols essentially tie together the physical constraints of the system with the data communication protocols for optimization to the hardware. In this way, fabrics can offer higher-utilization with stricter quality of service guarantees. They may also be able to offer less expensive, lower latency and more energy-efficient design.

However, current fabric architectures are not standardized (e.g., not publicly available) and will not interoperate seamlessly with other heterogeneous architectures. Further, fabric designs do not allow multi-hop routing decisions to be made with visibility into the fabric and do not allow common trouble-shooting, monitoring, and maintenance between the fabric and packet domain.

Within the fabric switch architecture, the data packets are communicated via the communications links 220 between the switching devices 210, 230 using a proprietary (not publicly available) packet protocol. Some examples of such proprietary fabric protocols include those developed by Juniper Networks (referred to as “Q-Fabric”) and Cisco Systems (referred to as “FabricPath”).

At present, data center operators must choose between a packet-based interconnect (using a standards-based packet protocol) and a fabric-based interconnect (using a proprietary packet protocol). Both approaches have advantages and disadvantages and each is more appropriate for particular applications.

Accordingly, there is needed a new switch architecture that can operate seamlessly with existing packet switch architectures and fabric switch architectures, by allowing packet devices to be directly connected via packet switch interfaces while simultaneously allowing low-latency and massively scaled applications to be directly attached via fabric switch interfaces.

### SUMMARY

According one embodiment of the present disclosure, there is provided a data center switching system that includes a first switching device, a routing/switching device, a core switching device and communication links. The first switching device has a plurality of external packet interfaces and a plurality of external fabric interfaces. The external packet interfaces are configured to receive and transmit data packets in accordance with a standards-based packet protocol, while the external fabric interfaces are configured to receive data packets and transmit data packets in accordance with a fabric protocol. The routing/switching device is coupled to the plurality of external packet interfaces via a first communications link, and the first communications link is operable for transporting data packets in accordance with the standards-based packet protocol. The core switching device has a packet interface and a fabric interface, the packet interface is coupled to the routing/switching device via a second communications link which is operable for transporting data packets in accordance with the standards-based packet protocol. A third communications link between the plurality of external fabric interfaces and the fabric interface of the core switching device is operable for transporting data packets in accordance with the fabric protocol.

According to another embodiment of the present disclosure, there is provided a method of routing packets in a data center switching system. The method includes receiving at a first switching device a first data packet in accordance with a standards-based packet protocol; transmitting the first data packet to a core switching device according to the standards-based packet protocol; receiving at the first switching device a second data packet; and transmitting the second data packet to the core switching device according to the fabric protocol.

In accordance with yet another embodiment of the present disclosure, there is provided a hybrid packet switching system having a first switching device, a core switching device, and a first communications link and a second communications link therebetween. The first switching device includes a first plurality of external data packet interfaces and a second plurality of external data packet interfaces. The first plurality of external data packet interfaces are configured to receive and transmit data packets in accordance with a first data packet protocol, while the second plurality of external data packet interfaces are configured to receive and transmit data packets in accordance with a second data packet protocol. The core switching device includes a first data packet interface and a second data packet interface. The first communications link is coupled between the first plurality of external data packet interfaces and the first data packet interface and is operable for transporting data packets in accordance with the first data packet protocol. The second communications link is coupled between the second plurality of external data packet interfaces and the second data packet interface and is operable for transporting data packets in accordance with the second data packet protocol.

Other technical features may be readily apparent to one skilled in the art from the following figures, descriptions, and claims.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a system diagram depicting a conventional packet switch architecture;

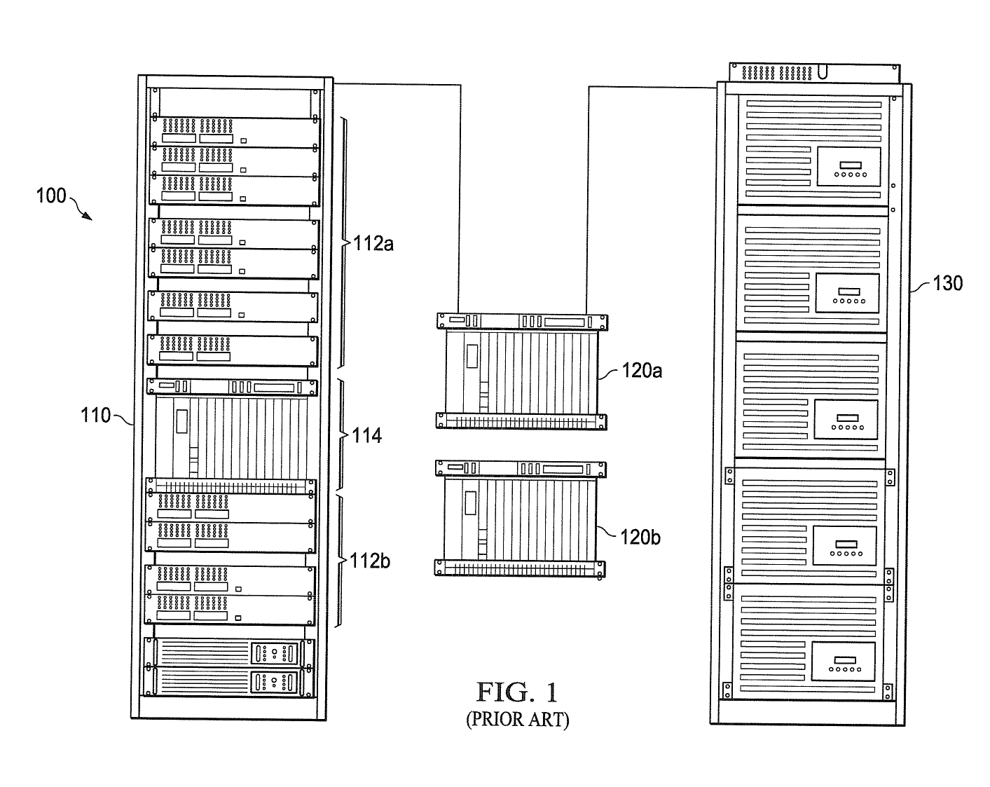

FIG. 2 is a system diagram depicting a fabric switch architecture;

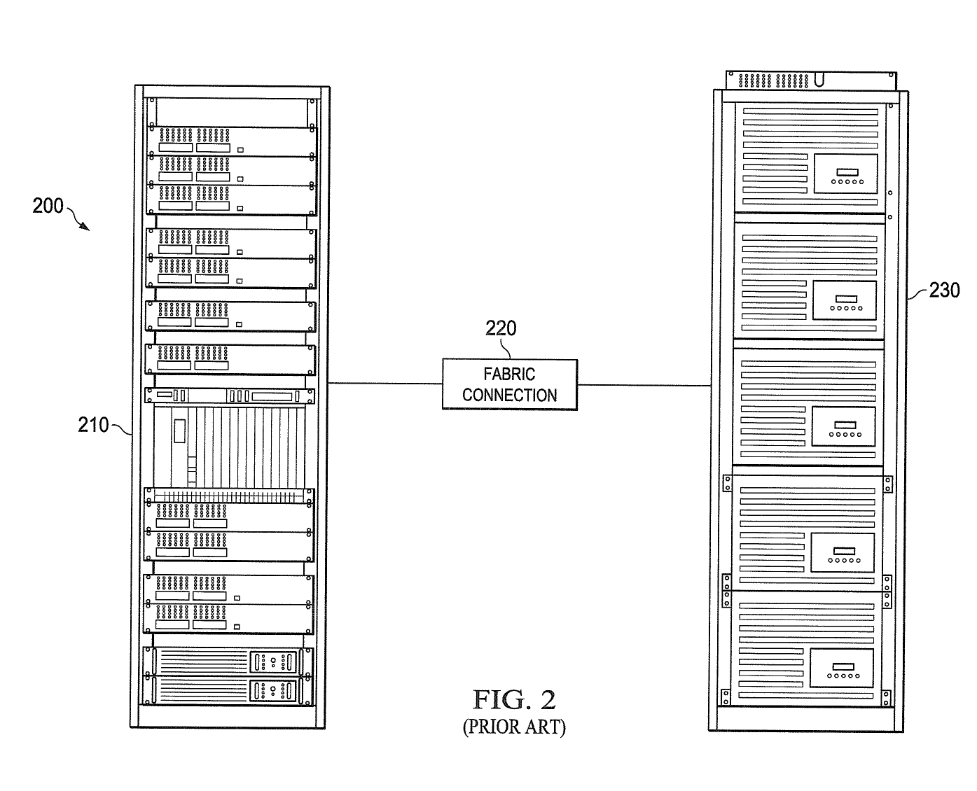

FIG. 3 is an overall system and block diagram illustrating a hybrid packet/fabric switch architecture in accordance with the present disclosure; and

FIG. 4 is a block diagram of a device that may be utilized in implementing the switching devices shown in FIG. 3.

### DETAILED DESCRIPTION

The construction and practice of various embodiments are discussed in detail below. It should be appreciated, however, that the present disclosure provides many applicable inventive concepts that can be embodied in a wide variety of specific contexts. Though specific embodiments discussed herein are merely illustrative of specific ways to make and practice the teachings and technology herein, they do not limit the scope of this disclosure.

Reference to “standards” or “standards-based packet protocol” in the foregoing or following text is meant to refer to existing and future versions of the standards or standards-based protocol—those that are publicly available and defined according to the standard. A standard protocol is the opposite of a “fabric protocol” in which the protocol is not publicly available and defined, and may also be referred to as “proprietary.” It will be understood that the system 300 may also be configured to include various devices or components, not shown, or be designed with different configurations. In this example, the system 300 is part of (or communicates with) a larger communication services network (not shown).

This disclosure includes an innovative hardware architecture configured or structured to have packet mode and fabric mode connections and transmit packets using a standards-based packet protocol and a fabric protocol, respectively. In addition, other example embodiments provide methods and hardware components configured to connect the packet and fabric domains together for seamless transport and/or management, including conversion from one protocol to the other protocol.

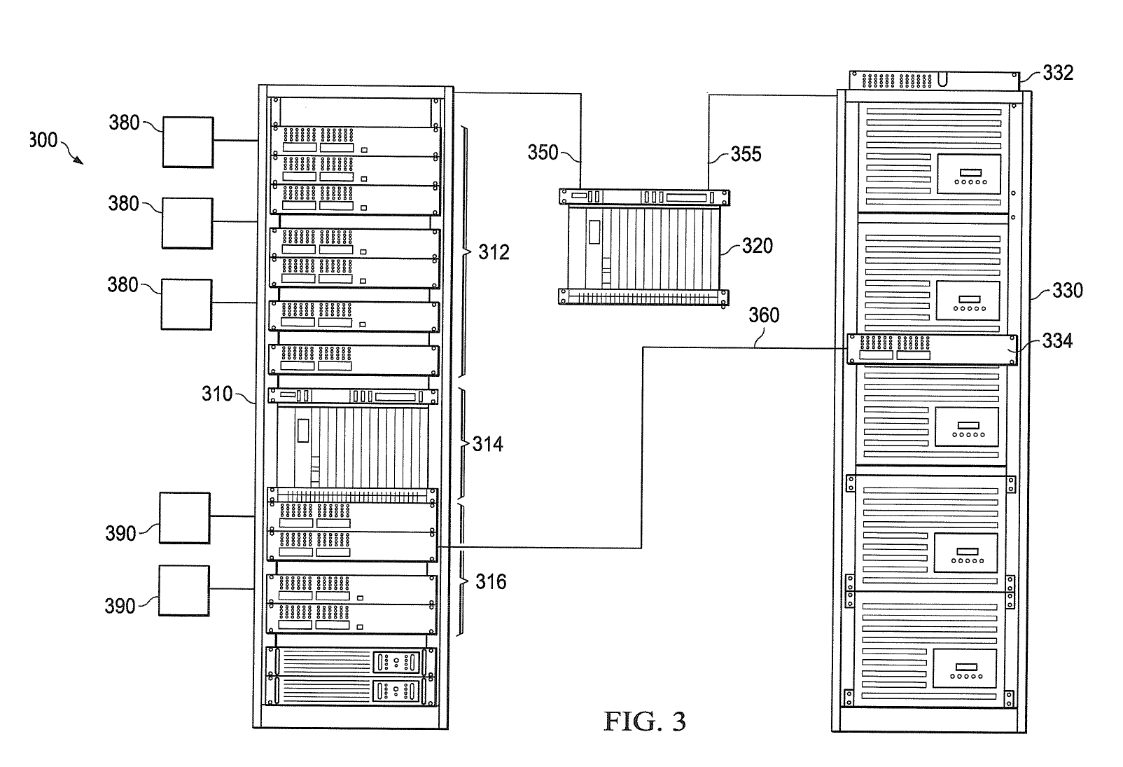

Turning now to FIG. 3, there is shown a diagram of an example hybrid packet/switch architecture or system 300 in accordance with the present disclosure.

In this example embodiment, the system 300 (e.g., data center) includes a first switching device 310, a second switching device 320 and a core data center switching device 330. As will be appreciated, the term “switching device” refers to a device that has switching and/or routing capabilities, and are often referred to as a router or a switch, and the term “router, “switch” and “router/switch” are used interchangeably herein. In addition, although only one of each device 310, 320, 330 are shown, additional such devices may be incorporated within the data center system 300.

The second switching device 320 may be configured as a TORS for gathering and routing data packets configured in accordance with a standards-based packet protocol into a communications pipe having large bandwidth. One example of TORS 320 may be those switches from Huawei Technologies, such as the CE5800 and CE680 TOR switches.

As shown in FIG. 3, the switching device 310 includes a set of external packet interfaces 312, an internal fabric interconnect 314, and a set of external fabric interfaces 316. The external packet interfaces 312 are operable for coupling to one or more external packet elements/devices 380 for receiving/transmitting data packets between the system 300 and the external packet elements/devices 380, such as for example, servers, routers, gateways, end systems, etc. The internal fabric interconnect 314 provides switching/interconnect functionality between the external packet interfaces 312.

The external fabric interfaces 316 are operable for coupling the system 300 to one or more external fabric elements/devices 390 for receiving/transmitting data packets between the system 300 and the external fabric elements/devices 390 in accordance with, or intended to be used with, a fabric protocol. In one embodiment, the external fabric interfaces 316 have predefined functionality (e.g., predefined) such that standard data packets received from the elements/devices 390 are intended to be forwarded in accordance with a fabric protocol (in the fabric domain). This may be accomplished by using specific ports on the external interfaces intended for fabric protocol use in the system 300. In this embodiment, the fabric interface 316 adds a fabric header to the packets received from the elements/devices 390, and may modify them further, to generate packets compliant with the fabric protocol in use. In other words, the external devices 390 may be external packet networks/devices operating in accordance with a standards-based packet protocol, and the interfaces 316 include functionality for translating or modifying the received packets complying with the standards-based packet protocol into packets complying with a fabric protocol. Similarly, the interfaces 316 would include functionality for translating packets complying with the fabric protocol (e.g., received from device 330) into packets complying with the standards-based packet protocol. Such modification may be as simple as adding/removing a fabric header, but may also include other modifications in accordance with the particular desire fabric protocol.

In another embodiment, the external fabric elements/devices 390 may already transmit packets to the interfaces 316 in accordance with the fabric protocol, and the devices 390 (or one or more devices upstream) have generated the fabric data packets.

Interconnecting a first portion of the first switching device 310 (e.g., the external packet interfaces 312 of the device 310) and the TORS 320 are one or more communications links 350 operating in accordance with a standards-based packet protocol. Similarly, interconnecting the TORS 320 and the core switching device 330 (e.g., a packet TORS interface 332 of the device 330) are one or more communication links 355 operating in accordance with the standards-based packet protocol. Thus, data packets transported on communication links 350, 355 between the switching device 310 and the core switching device 330 are transported in accordance with the standards-based packet protocol.

Similar to the conventional prior art packet switch architecture, data packets conforming to the standards-based packet protocol received at the switching device 310 (and transmitted externally) are communicated via communications links 350, 355 between the switching devices 310, 320, 330 using a publicly available and known standards-based packet protocol, such as Ethernet. Other examples of standards-based protocols include Asynchronous Transfer Mode (ATM), Internet Protocol (IP), and Internet Protocol Over Ethernet (IPOE). As will be appreciated, the term “standards-based packet protocol” refers to a published or publicly available standard describing or defining the parameters and operation of the protocol.

Interconnecting a second portion of the first switching device 310 (e.g., the external fabric interfaces 316 of the device 310) and the core switching device 330 (e.g., a fabric TORS interface 334 of the device 330) are one or more communications links 360 operating in accordance with a fabric protocol. Data packets transported on communication link 360 between the switching device 310 and the core switching device 330 are transported in accordance with the fabric protocol. As will be appreciated, the communication link 360 may be physical, logical or both.

The configuration of the system 300 has the utility of allowing legacy and traditional packet elements/devices 380 to be directly connected to the system 300 via the conventional external packet interfaces 312 while simultaneously allowing low-latency and massively scaled applications (fabric elements/devices 390) to be directly attached through the external fabric interfaces 316. For example, in applications requiring high speed computation and fast turnaround within the system 300, such as a stock trading application, using a fabric protocol is especially beneficial as it can be streamlined to provide the desire functionality and faster data transport (when speed is critical).

As will be appreciated, in general terms, the data center 300 includes two switching domains—a packet switch domain and a fabric switch domain. The packet switch domain conceptually includes the external packet interfaces 312 (of device 310), the communication link(s) 350, the TORS 320, the communication link(s) 355, and the TORS packet interface 332 (of the core switch 330). Meanwhile, the fabric switch domain conceptually includes the external fabric interfaces 316 (of device 310), the communication link(s) 360, and the TORS fabric interface 334 (of the core switch 330).

Such a hybrid packet/fabric data center switching system 300 enables a data center to process data packets conforming to standards-based packet protocols, as well as data packets conforming to a fabric protocol (e.g., data packets processing requiring specialized processing or other high quality of service. Though these two domains are generally maintained separately within the system 300, the system 300 further includes functionality enabling routing/translation of data packets between the packet switch domain and the fabric switch domain. As will be appreciated, one or more devices (not shown in the figures) may be included at one or more different locations (as desired) within the system 300 with this functionality. As will be appreciated, such device(s) will include hardware, software and/or firmware to enable this routing and/or translation—depending on the particular standards-based packet protocol and fabric protocol adopted in the system 100.

Two potential embodiments are described herein for routing within the system 300—opaque routing and transparent routing.

Opaque routing allows the packet domain to view the fabric domain as being directly connected. In other words, the router/switch device 320 sees the fabric devices/elements 390 connected directly to the fabric (i.e., connected to the external fabric interfaces 316) as being a part of the router/switch device 320 itself and has no visibility into the structure of the fabric itself. From the viewpoint of the devices 390, there is a single link between those devices and the core switching device 330. Thus, all of the intermediate specific devices or links between 390 and 330 are not seen, and the path is considered a single link.

This embodiment has several implications. First, the router/switch device 320 typically needs to discover and maintain the directly connected fabric elements/devices 390 at a layer 2 and potentially layer 3. Next, the router/switch device 320 will advertise links of the directly connected fabric elements/devices 390 as its own. While this is relatively well-understood when the elements are co-resident in the router/switch device 320 itself, it is more complicated when the elements/devices 390 are connected by the external fabric interfaces 316 for the following reasons:

1. The elements/devices 390 may form an arbitrary mesh rather than being associated with fixed slots in a chassis;

2. The elements/devices 390 may use special protocols that operate over a fabric only for the discovery and dissemination of endpoint addresses; and

3. An additional configuration is needed having a special protocol to add arbitrary and unidirectional pathways through the fabric for policy control.

For example, an administrator may subdivide the fabric into several distinct sub-fabrics that do not inter-communicate so that each sub-fabric forms a secure virtual private network. A typical example of this would be to separate the information technology (IT) traffic of a corporate human resources (HR) department from the corporate engineering department. The recent trend in virtualization and multi-tenancy will only make this more pronounced.

In a different embodiment, transparent routing allows integration of the fabric paths with the packet network. In this embodiment, topology information from within the fabric and network topology information outside the fabric are used to make forwarding decisions. Thus, traffic may be routed optimally between the two domains. Further, transparent routing entails the external devices having knowledge of all the devices between it and the switching device. For example, the devices 390 would know how many devices between itself and the core switching device 330.

There are two configurations or methods for the transfer of information between the fabric and packet domains. In one configuration, the fabric is seen as a single hop mesh and can be applied to different layer 3 protocols in different ways. One implementation may be to import the fabric domain into a layer 3 packet domain using open shortest path first (OSPF) technology. In this way, the external fabric interfaces 316 may be treated as non-broadcast multi-access interfaces. Other similar claims are made for intermediate system to intermediate system (IS-IS)). Another implementation may be to import the topology of the internal fabric into the packet domain. In this way, links within the fabric are treated as single hops within the layer 3 packet domain. This has benefits in terms of enabling a higher number of optimal paths to be determined using the additional layer 3 information. Yet another implementation may be to translate the link information with the understanding that the links will not be used in the same way they would in the layer 3 packet domains. More specifically, in layer 3, each hop will determine the next hop of a packet whereas in a fabric domain a packet can be broken up and sent over multiple paths. Thus, the capabilities of the fabric will typically need to be advertised into the layer 3 domain with consideration of this quality.

The other configuration or method includes integrating the layer 3 domain into the switch domain using traffic-engineering methods. Here, a multiprotocol label switching (MPLS) label switched path (LSP) could be provisioned with a path through the layer 3 network integrated with a seamless path through the fabric.

Finally, in another embodiment the domains may be linked using a “defined networking controller”. In this embodiment, the controller may use the fabric topology data along with the layer 3 data as part of path determination. Further, the controller may use path determination algorithms that have the constraint of avoiding multipath through the fabric. Moreover, per-hop policy enforcement capabilities may be learned from the fabric during automatic discovery or through static provisioning.

At least some of the devices, such as devices 310, 320 and 330, described in the disclosure may be implemented each as a network apparatus or component, such as a network node or unit. For instance, the features/methods in the disclosure may be implemented using devices including hardware, firmware, and/or software installed to execute on hardware. These devices 310, 320, 330 may be any device that transports, switches or routes frames or data packets through a network, e.g., a switch, router, bridge, server, etc.

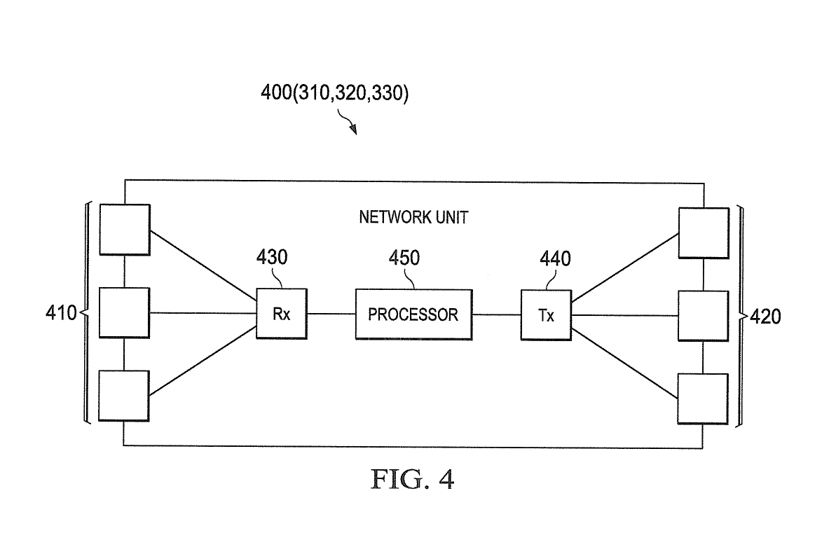

As illustrated in FIG. 4, the devices 310, 320, 330 may be implemented in accordance with a device 400 that includes at least a plurality of ingress ports 410 and egress ports 420, a receiver 430 coupled to the ingress ports 410 (for receiving data packets from other devices), a transmitter 440 coupled to the egress ports 420 (for transmitting data packets to other devices), and a processor 450 (or controller) coupled to the receiver 430 and to the transmitter 440 for routing or switching data packets among the ingress and egress ports. The processor 450 may include one or more processors, or multi-core processor(s). Though not shown, the device 400 includes memory that stores various operating instructions (e.g., firmware, software) which controls the operation of the device 400 as desired. Further, the ingress ports 410 and/or the egress ports 420 may be constructed or configured with components to provide electrical and/or optical transmitting and/or receiving functionality.

Although features and elements are described above in particular combinations, each feature or element can be used alone without the other features and elements or in various combinations with or without other features and elements. Some or all of the functions or processes of the one or more of the devices or methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A data center switching system comprising:
a first switching device having a plurality of external packet interfaces and a plurality of external fabric interfaces, the external packet interfaces configured to receive and transmit data packets in accordance with a standards-based packet protocol, the external fabric interfaces configured to receive data packets and transmit the received data packets in accordance with a fabric protocol;
a routing/switching device coupled to the plurality of external packet interfaces via a first communications link, the first communications link operable for transporting data packets in accordance with the standards-based packet protocol;
a core switching device having a packet interface and a fabric interface, the packet interface coupled to the routing/switching device via a second communications link, the second communications link operable for transporting data packets in accordance with the standards-based packet protocol; and
a third communications link coupled between the plurality of external fabric interfaces and the fabric interface of the core switching device, the third communications link operable for transporting data packets in accordance with the fabric protocol.

2. The data center system in accordance with claim 1 wherein the standards-based packet protocol is a one of Ethernet, Asynchronous Transfer Mode (ATM), Internet Protocol (IP) or Internet Protocol Over Ethernet (IPOE).

3. The data center system in accordance with claim 1 wherein the first switching device is further configured to convert a data packet received in accordance with a standards-based packet protocol into a data packet in accordance with a fabric protocol.

4. The data center system in accordance with claim 3 wherein the first switching device is further configured to convert a data packet received in accordance with a fabric protocol into a data packet in accordance with a standards-based packet protocol.

5. The data center system in accordance with claim 1 wherein the core switching device is further configured to convert a data packet received in accordance with a standards-based packet protocol into a data packet in accordance with a fabric protocol.

6. The data center system in accordance with claim 5 wherein the core switching device is further configured to convert a data packet received in accordance with a fabric protocol into a data packet in accordance with a standards-based packet protocol.

7. The data center system in accordance with claim 1 wherein the first switching device comprises:
a device configured to at least a one of: convert data packets received in accordance with a standards-based packet protocol to data packets in accordance with a fabric protocol or convert data packets received in accordance with a fabric protocol to data packets in accordance with a standards-based data protocol.

8. The data center system in accordance with claim 1 wherein the core switching device comprises:
a device configured to at least a one of: convert data packets received in accordance with a standards-based packet protocol to data packets in accordance with a fabric protocol or convert data packets received in accordance with a fabric protocol to data packets in accordance with a standards-based data protocol.

9. The data center system in accordance with claim 1 further comprising:
one or more devices for translating or converting data packets from one protocol to another protocol.

10. A method of routing packets in a data center switching system comprising:
receiving at a first switching device a first data packet in accordance with a standards-based packet protocol;
transmitting the first data packet to a core switching device according to the standards-based packet protocol;
receiving at the first switching device a second data packet; and
transmitting the second data packet to the core switching device according to the fabric protocol.

11. The method in accordance with claim 10 wherein transmitting the first data packet to the core switching device comprises:
transmitting the first data packet over a first communications link to a second switching device in accordance with the standards-based packet protocol; and
transmitting the first data packet over a second communications link, from the second switching device to the core switching device in accordance with the standards-based packet protocol.

12. The method in accordance with claim 10 wherein the standards-based packet protocol is a one of Ethernet, Asynchronous Transfer Mode (ATM), Internet Protocol (IP) or Internet Protocol Over Ethernet (IPOE).

13. The method in accordance with claim 10 further comprising:
converting a received data packet in accordance with a standards-based packet protocol to a data packet in accordance with a fabric protocol.

14. The method in accordance with claim 11 further comprising:
converting a received data packet in accordance with a standards-based packet protocol to a data packet in accordance with a fabric protocol.

15. The method in accordance with claim 10 further comprising:
converting a received data packet in accordance with a fabric protocol to a data packet in accordance with a standards-based packet protocol.

16. The method in accordance with claim 11 further comprising:
converting a received data packet in accordance with a fabric protocol to a data packet in accordance with a standards-based packet protocol.

17. A hybrid packet switching system comprising:
a first switching device having a first plurality of external data packet interfaces and a second plurality of external data packet interfaces, the first plurality of external data packet interfaces configured to receive and transmit data packets in accordance with a first data packet protocol, the second plurality of external data packet interfaces configured to receive and transmit data packets in accordance with a second data packet protocol;
a core switching device having a first data packet interface and a second data packet interface;
a first communications link coupled between the first plurality of external data packet interfaces and the first data packet interface, the first communications link operable for transporting data packets in accordance with the first data packet protocol; and
a second communications link coupled between the second plurality of external data packet interfaces and the second data packet interface, the second communications link operable for transporting data packets in accordance with the second data packet protocol.

18. The hybrid packet switching system in accordance with claim 17 wherein the first data packet protocol is a standards-based packet protocol.

19. The hybrid packet switching system in accordance with claim 18 wherein the standards-based packet protocol is a one of Ethernet, Asynchronous Transfer Mode (ATM), Internet Protocol (IP) or Internet Protocol Over Ethernet (IPOE).

20. The hybrid packet switching system in accordance with claim 17 wherein the first data packet protocol is a standards-based packet protocol, and the second data packet protocol is a fabric protocol.
